(19) United States
(12) Patent Application Publication
(10) Pub. No.: US 2026/0231909 A1
(43) Pub. Date: Aug. 13, 2026

(54) ADJUSTABLE LENGTH LEASH WITH PULLEY-LIKE ADJUSTMENT SYSTEM

(71) Applicant: GAGANRAJ RIHAL, PASADENA, CA (US)

(72) Inventor: GAGANRAJ RIHAL, PASADENA, CA (US)

(21) Appl. No.: 19/536,426

(22) Filed: Feb. 11, 2026

Related U.S. Application Data
(60) Provisional application No. 63/757,294, filed on Feb. 11, 2025.

(51) Int. Cl. A01K 27/00

(52) U.S. Cl. CPC A01K 27/003

(57) ABSTRACT

A leash comprising a leash strap extending between a first end and a second end, an adjustment bracket positioned along the leash strap, the leash strap being threaded through the adjustment bracket to form a pulley-like system, a loop strap connected at one end to the adjustment bracket and at another end to the leash strap via a loop ring, and the loop strap forming a secondary handle that enables dynamic length adjustment of the leash by applying a force to the loop strap in a first direction, wherein applying the force to the loop strap in the first direction causes the adjustment bracket to slide along the leash strap to shorten an effective length of the leash.

### CROSS-REFERENCE TO RELATED APPLICATIONS

This application claims priority to U.S. Provisional Patent Application No. 63/757,294, filed Feb. 11, 2025, which is hereby incorporated by reference in its entirety.

### FIELD OF INVENTION

The present disclosure relates to animal restraint devices, and more particularly to an adjustable-length leash incorporating a pulley-like adjustment system that enables dynamic length modification during use.

### BACKGROUND

Animal leashes serve as a primary means of restraining and controlling animals, particularly dogs, during walks, training sessions, and various outdoor activities. Conventional leashes generally fall into two categories: fixed-length leashes and retractable leashes, each presenting distinct characteristics and limitations.

Fixed-length leashes, commonly referred to as flat leashes or standard leashes, typically comprise a length of webbing, nylon, leather, or similar material with a handle at one end and a clip or clasp at the other end for attachment to an animal's collar or harness. These leashes provide direct physical connection between the handler and the animal, offering reliable control and leverage. However, fixed-length leashes do not permit adjustment of the leash length during use without the handler manually repositioning their grip along the leash material, a technique sometimes referred to as “choking up” on the leash. Some handlers add intermediate handles or tie knots in the leash to create additional grip points, though such modifications may be cumbersome or may not provide the desired level of adjustability.

Retractable leashes employ mechanical systems housed within a handle unit that allow a thin cord or tape to extend and retract through spring-loaded mechanisms. These devices permit the animal to move at varying distances from the handler while the retraction mechanism maintains tension on the line. However, the thin cord or tape material used in retractable leashes may provide limited leverage and control over the animal, particularly when the animal pulls or lunges. The mechanical components within retractable leashes may also be susceptible to jamming, tangling, or malfunction, and the retraction mechanisms may not permit precise control over the leash length, especially during retraction operations.

Various approaches have been developed to address the limitations of conventional leashes. Some designs incorporate buckles, slides, or other adjustment mechanisms that allow the handler to modify the leash length. Other designs employ elastic or bungee materials to provide shock absorption when the animal pulls against the leash. Still other designs incorporate multiple handles or grip points positioned along the length of the leash to provide the handler with options for controlling the animal at different distances.

Handlers may encounter situations during walks or activities where different leash lengths would be beneficial. In open areas or relaxed environments, a longer leash length may allow the animal greater freedom to explore and move naturally. In crowded areas, near traffic, or in situations where closer control is desired, a shorter leash length may be preferable. The ability to transition between different leash lengths during use without complex mechanical systems or cumbersome manual adjustments may provide handlers with enhanced flexibility and control.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a leash is provided. The leash includes a leash strap extending between a first end and a second end. An adjustment bracket is positioned along the leash strap, with the leash strap being threaded through the adjustment bracket to form a pulley-like system. A loop strap is connected at one end to the adjustment bracket and at the other end to the leash strap via a loop ring. The loop strap forms a secondary handle that enables dynamic length adjustment of the leash by applying a force to the loop strap in a first direction. Applying the force to the loop strap in the first direction causes the adjustment bracket to slide along the leash strap to shorten an effective length of the leash.

According to other aspects of the present disclosure, the leash may include one or more of the following features. The leash may further include a handle strap positioned at the first end of the leash strap, with the handle strap forming a primary handle loop for gripping by the user. The leash may further include a swivel connector connecting the handle strap to the leash strap, with the swivel connector configured to allow rotational movement to prevent tangling during use. The leash may further include a handle ring positioned at the first end of the leash strap proximate the swivel connector. The leash may further include a leash clip attached at the second end of the leash strap, with the leash clip configured for attachment to a collar or harness of an animal. The leash may further include an elastic band positioned distal to the second end of the leash strap, with the elastic band configured to provide shock absorption during use. The leash strap may comprise a webbing material. The loop ring may comprise a D-ring or an O-ring. The leash may be configured to be adjustable between a full length configuration and a shortened length configuration, with the shortened length configuration being approximately half of the full length configuration. Applying a force to the loop strap in a second direction opposite the first direction may cause the effective length of the leash to extend. The first direction may be toward a user and the second direction may be away from the user such that pulling the loop strap toward the user shortens the effective length of the leash and pushing the loop strap away from the user extends the effective length of the leash. The first direction may be away from a user and the second direction may be toward the user such that pushing the loop strap away from the user shortens the effective length of the leash and pulling the loop strap toward the user extends the effective length of the leash.

According to another aspect of the present disclosure, a method of adjusting a length of a leash is provided. The method includes gripping a handle strap positioned at a first end of a leash strap with a first hand. The method includes grasping a loop strap with a second hand, with the loop strap being connected at one end to an adjustment bracket and at the other end to the leash strap via a loop ring, and the adjustment bracket being positioned along the leash strap, wherein the leash strap is threaded through the adjustment bracket to form a pulley-like system. The method includes applying a force to the loop strap in a first direction to cause the adjustment bracket to slide along the leash strap, thereby shortening an effective length of the leash.

According to other aspects of the present disclosure, the method may include one or more of the following features. The method may further include applying a force to the loop strap in a second direction opposite the first direction to extend the effective length of the leash. The first direction may be toward a user and the second direction may be away from the user such that pulling the loop strap toward the user shortens the effective length of the leash and pushing the loop strap away from the user extends the effective length of the leash. The first direction may be away from a user and the second direction may be toward the user such that pushing the loop strap away from the user shortens the effective length of the leash and pulling the loop strap toward the user extends the effective length of the leash. The leash may further include an elastic band positioned distal to a second end of the leash strap, with the elastic band providing shock absorption when an animal attached to the leash pulls against the leash.

According to another aspect of the present disclosure, a leash system is provided. The leash system includes a leash strap extending between a first end and a second end. A handle strap is positioned at the first end of the leash strap, with the handle strap forming a primary handle loop. A swivel connector connects the handle strap to the leash strap. An adjustment bracket is positioned along the leash strap, with the leash strap being threaded through the adjustment bracket to form a pulley-like system that enables dynamic length adjustment. A loop strap is connected to the adjustment bracket via a loop ring, with the loop strap forming a secondary handle. A leash clip is attached at the second end of the leash strap. A collar or harness is configured to be worn by an animal, with the leash clip being attachable to the collar or harness.

According to other aspects of the present disclosure, the leash system may include one or more of the following features. Applying a force to the loop strap in a first direction may cause the adjustment bracket to slide along the leash strap to shorten an effective length of the leash, and applying a force to the loop strap in a second direction opposite the first direction may cause the effective length of the leash to extend. The first direction may be toward a user and the second direction may be away from the user such that pulling the loop strap toward the user shortens the effective length of the leash and pushing the loop strap away from the user extends the effective length of the leash.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a top view of a leash in an extended configuration, according to aspects of the present disclosure.

FIG. 2 illustrates multiple views of the leash of FIG. 1, according to an embodiment.

FIG. 3 illustrates multiple views of a leash as an alternate embodiment, according to aspects of the present disclosure.

FIG. 4 illustrates a perspective view of the leash of FIG. 3 in use with a dog, according to an embodiment.

FIG. 5 illustrates a side view of a leash in an extended configuration with an enlarged detail view, according to aspects of the present disclosure.

FIG. 6 illustrates a perspective view of a leash in use with a person walking a dog, according to an embodiment.

FIG. 7 illustrates a perspective view of the leash of FIG. 6 in use with a person grasping a loop strap, according to aspects of the present disclosure.

FIG. 8 illustrates a perspective view of the leash of FIG. 6 in a shortened length configuration, according to an embodiment.

FIG. 9 illustrates a perspective view of the leash of FIG. 6 in an extended length configuration, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to an adjustable leash configured to provide handlers with dynamic control over leash length during use. The adjustable leash combines the convenience and flexibility associated with retractable leashes with the reliability, security, and direct control characteristic of traditional fixed flat leashes.

Conventional retractable leashes employ mechanical retraction systems housed within plastic handles that allow a thin cord or tape to extend and retract. However, such mechanical systems present several drawbacks. The thin leash material provides limited leverage and control over an animal, particularly when the animal pulls or lunges. Additionally, the retraction mechanisms may jam, tangle, or fail to accurately control the length of the leash, especially during retraction. These limitations render conventional retractable leashes suitable primarily for small or well-behaved animals.

Traditional fixed flat leashes, while providing reliable control and direct physical connection between handler and animal, lack the ability to dynamically adjust length during use. Handlers seeking to shorten a traditional leash may resort to choking up on the leash material, adding intermediate handles, or tying knots to create grip points. Such approaches may be cumbersome and may not provide the rapid, seamless length adjustment desired in various situations.

The adjustable leash described herein addresses these limitations by enabling a handler to dynamically shift the effective length of the leash while in use. The adjustable leash may transform from a full extended length to a shortened length, or any length in between, without relying on complex mechanical retraction mechanisms. The adjustment may be achieved through a pulley-like system that allows the handler to shorten the leash for situations requiring closer control, such as in crowded areas, near traffic, or when quick restraint is desired, and to extend the leash for situations where the animal may benefit from greater freedom of movement, such as during relaxed exploration. The adjustment process may be intuitive and immediate, allowing seamless transitions between lengths while maintaining firm, non-elastic control over the animal. The adjustable leash avoids the tangling, jamming, and line retraction issues common in conventional retractable leashes while providing the direct physical control associated with standard flat leashes.

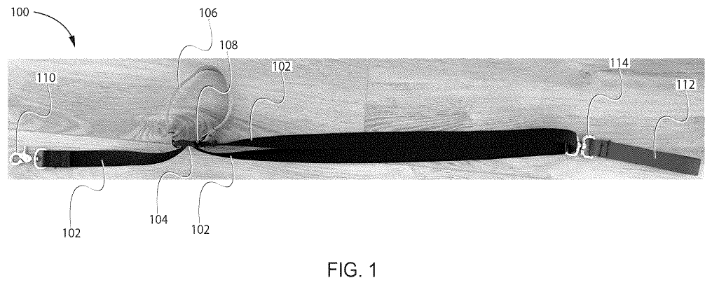

Referring to FIG. 1, a leash 100 is shown in a top view in an extended configuration. The leash 100 includes a leash strap 102 that forms the primary body of the leash 100. The leash strap 102 extends between a first end and a second end, with the leash strap 102 appearing as a webbing material in the illustrated embodiment. The leash strap 102 may comprise webbing material or other suitable materials such as nylon, polyester, or leather.

With continued reference to FIG. 1, an adjustment bracket 104 is positioned along the leash strap 102. The adjustment bracket 104 may comprise a ladder lock or other adjustment mechanisms configured for use in modifying the effective length of the leash 100. The leash strap 102 is threaded through the adjustment bracket 104 to form a pulley-like system. The adjustment bracket 104 with the leash strap 102 weaved through the adjustment bracket 104 creates the pulley-like system that may dynamically halve the overall length of the leash 100.

A loop strap 106 is connected at one end to the adjustment bracket 104 and at another end to the leash strap 102 via a loop ring 108. The loop strap 106 forms a secondary handle that enables dynamic length adjustment of the leash 100. The loop ring 108 may comprise a D-ring, an O-ring, or other ring configurations suitable for connecting the loop strap 106 to the leash strap 102.

At the second end of the leash 100, a leash clip 110 is provided. The leash clip 110 is configured for attachment to a collar or harness of an animal. At the first end of the leash 100, a handle strap 112 is positioned. The handle strap 112 forms a primary handle loop for gripping by a user. As further shown in FIG. 1, a swivel connector 114 connects the handle strap 112 to the leash strap 102. The swivel connector 114 allows rotational movement to prevent tangling during use. The arrangement of the leash strap 102 threaded through the adjustment bracket 104 enables the leash 100 to be dynamically adjusted in length through the interaction of the adjustment bracket 104 with the leash strap 102.

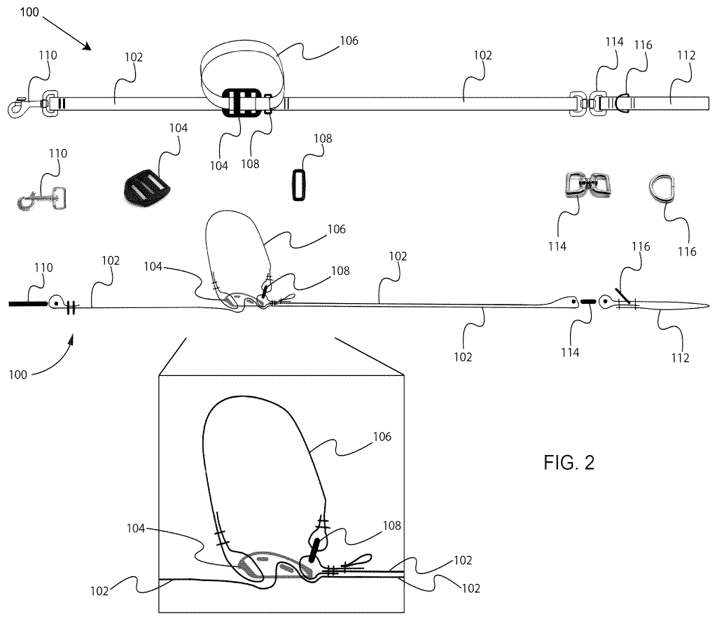

Referring to FIG. 2, multiple views of the leash 100 are shown, including a top orthogonal view, a side view, and a detailed close-up view of a central portion of the leash 100. The top view shows the leash 100 in an extended configuration with the loop strap 106 positioned centrally along the leash strap 102. The side view depicts the leash 100 with the loop strap 106 extending upward from the leash strap 102, demonstrating how the adjustment bracket 104 and the loop ring 108 interact with the leash strap 102. In the illustrated embodiment, the adjustment bracket 104 comprises a ladder lock.

With continued reference to FIG. 2, the detailed close-up view provides an enlarged perspective of the central portion where the adjustment bracket 104, the loop strap 106, and the loop ring 108 are assembled. The leash strap 102 interfaces with the adjustment bracket 104 by being threaded through multiple points of the adjustment bracket 104. The loop strap 106 is connected at one end to the adjustment bracket 104 and at another end to the leash strap 102 via the loop ring 108. This arrangement creates the pulley-like adjustment system that enables dynamic length adjustment of the leash 100.

As further shown in FIG. 2, a handle ring 116 is positioned at the first end of the leash strap 102 proximate the swivel connector 114. The handle ring 116 provides an additional attachment or grip point at the handle end of the leash 100. The handle strap 112 is positioned at the first end of the leash strap 102, and the handle strap 112 forms a primary handle loop for gripping by the user. The swivel connector 114 connects the handle strap 112 to the leash strap 102, and the swivel connector 114 is configured to allow rotational movement to prevent tangling during use.

The swivel connector 114 may comprise various rotational connection mechanisms. In some cases, the swivel connector 114 may comprise a ball-bearing swivel that provides smooth rotational movement under load. In some cases, the swivel connector 114 may comprise a snap swivel that combines a swiveling function with a snap closure. Other rotational connection mechanisms may be employed for the swivel connector 114 that allow rotational movement to prevent tangling during use.

In the embodiment shown in FIG. 2, the leash 100 is configured as a first version (V1) where the first direction is away from a user and the second direction is toward the user such that pushing the loop strap 106 away from the user shortens the effective length of the leash 100 and pulling the loop strap 106 toward the user extends the effective length of the leash 100. In this configuration, when the user pushes on the loop strap 106, the adjustment bracket 104 slides along the leash strap 102 to shorten the effective length of the leash 100. When the user releases or pulls the loop strap 106 toward the user, the effective length of the leash 100 extends, returning the leash 100 toward the full length configuration.

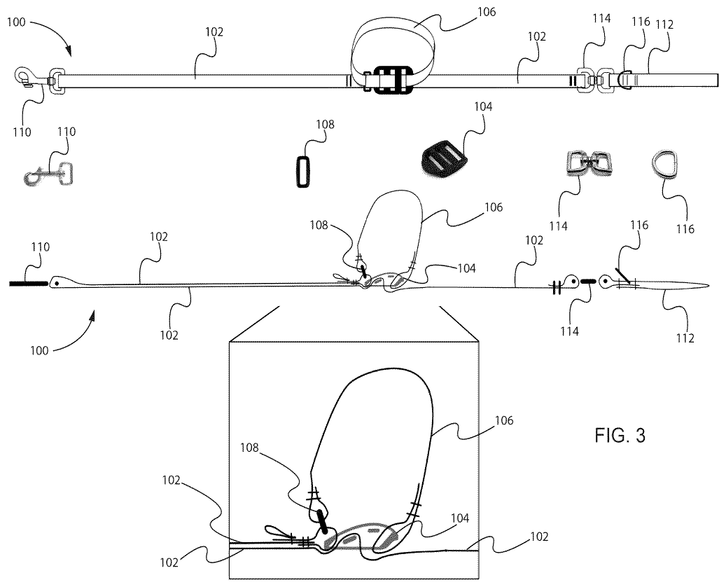

Referring to FIG. 3, an alternate embodiment of the leash 100 is shown, including an assembled view, an exploded view showing individual components, and a detailed inset view. The assembled view depicts the leash 100 in a complete configuration with all components connected. The exploded view displays the individual components including the loop ring 108, the adjustment bracket 104, the swivel connector 114, and the handle ring 116 separated from the leash strap 102 to illustrate the relationship and assembly configuration of the components. In the illustrated embodiment, the adjustment bracket 104 comprises a ladder lock. The detailed inset view at the bottom of FIG. 3 provides a closer examination of the central portion of the leash 100, showing how the leash strap 102 interfaces with the adjustment bracket 104, the loop strap 106, and the loop ring 108 to create the pulley-like adjustment system that enables dynamic length adjustment of the leash 100.

With continued reference to FIG. 3, the leash 100 is configured as a second version (V2) where the first direction is toward a user and the second direction is away from the user such that pulling the loop strap 106 toward the user shortens the effective length of the leash 100 and pushing the loop strap 106 away from the user extends the effective length of the leash 100. In this configuration, when the user pulls on the loop strap 106 toward the user, the adjustment bracket 104 slides along the leash strap 102 to shorten the effective length of the leash 100. When the user pushes the loop strap 106 away from the user, the effective length of the leash 100 extends, returning the leash 100 toward the full length configuration. This second version (V2) provides an alternative operational mode compared to the first version (V1) described previously with reference to FIG. 2, where pushing on the loop strap 106 shortens the leash 100.

As further shown in FIG. 3, the adjustment bracket 104 may be replaced with other adjustment bracket types that achieve the same function. In some cases, the adjustment bracket may comprise a tri-glide buckle. In some cases, the adjustment bracket may comprise a cam buckle. In some cases, the adjustment bracket may comprise other sliding adjustment mechanisms that allow the leash strap 102 to slide therethrough while providing a connection point for the loop strap 106. The selection of the adjustment bracket type may depend on factors such as the desired friction characteristics, the material of the leash strap 102, or the intended use environment of the leash 100.

The ladder lock is merely an example of an adjustment bracket, and other adjustment brackets, structures, or mechanisms may additionally or alternatively be used without departing from the scope of the invention. For example, the adjustment bracket may comprise a tri-glide buckle, a cam buckle, a friction buckle, a sliding bar adjuster, a cord lock, or other tensioning devices configured to allow the leash strap 102 to slide therethrough while providing a connection point for the loop strap 106. The adjustment bracket may also comprise custom-designed sliding mechanisms or pulley assemblies that achieve similar functionality.

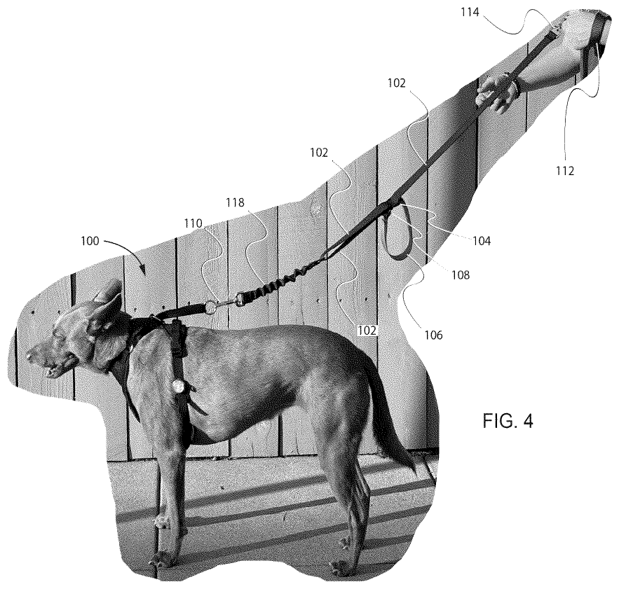

Referring to FIG. 4, a perspective view of the leash 100 is shown in use with a dog wearing a harness. The leash 100 extends from the dog's harness to a handler's hand, demonstrating the practical application of the leash 100 during use. As described previously, the leash strap 102 extends between a first end and a second end, with the leash strap 102 passing through the adjustment bracket 104 positioned along the length of the leash strap 102. The leash strap 102 is threaded through the adjustment bracket 104 to form a pulley-like system that enables dynamic length adjustment. The loop strap 106 is connected to the adjustment bracket 104 via the loop ring 108, and the loop strap 106 forms a secondary handle that enables dynamic length adjustment of the leash 100.

With continued reference to FIG. 4, an elastic band 118 is incorporated into the leash 100 adjacent the distal end of the leash strap 102. The elastic band 118 is configured to provide shock absorption and flexibility when the dog moves or pulls against the leash 100. The elastic band 118 may reduce jarring forces transmitted through the leash 100 when the dog lunges or changes direction suddenly. In some cases, the elastic band 118 may comprise a bungee cord material or other elastic materials that provide the desired shock absorption characteristics.

As further shown in FIG. 4, the leash clip 110 is attached at the second end of the leash strap 102. The leash clip 110 secures the leash 100 to the harness attachment point worn by the dog. The leash clip 110 is configured for attachment to a collar or harness of an animal. The leash clip 110 may comprise various clip types. In some cases, the leash clip 110 may comprise a bolt snap. In some cases, the leash clip 110 may comprise a trigger snap. In some cases, the leash clip 110 may comprise a carabiner clip. Other attachment mechanisms configured for attachment to a collar or harness of an animal may be employed for the leash clip 110.

The leash strap 102 may be attached to a harness worn by the animal. The harness provides an attachment point that distributes forces across the animal's body when the animal pulls against the leash 100. In some cases, the harness may include a back attachment point, a front attachment point, or multiple attachment points to which the leash clip 110 may be secured.

With continued reference to FIG. 4, the handle strap 112 is positioned at the first end of the leash strap 102, and the handle strap 112 forms a primary handle loop for gripping by the user. The swivel connector 114 connects the handle strap 112 to the leash strap 102, allowing rotational movement to prevent tangling during use. The configuration shown in FIG. 4 demonstrates the leash 100 in an extended position, with the handler maintaining control through the handle strap 112 while the dog has freedom of movement within the length of the leash strap 102.

The leash 100 may form part of a leash system. The leash system may comprise the leash 100 including the leash strap 102 extending between the first end and the second end, the handle strap 112 positioned at the first end of the leash strap 102 and forming the primary handle loop, the swivel connector 114 connecting the handle strap 112 to the leash strap 102, the adjustment bracket positioned along the leash strap 102 with the leash strap 102 being threaded through the adjustment bracket to form the pulley-like system that enables dynamic length adjustment, the loop strap 106 connected to the adjustment bracket via the loop ring 108 and forming the secondary handle, and the leash clip 110 attached at the second end of the leash strap 102. The leash system may further comprise a collar or harness configured to be worn by an animal, with the leash clip 110 being attachable to the collar or harness.

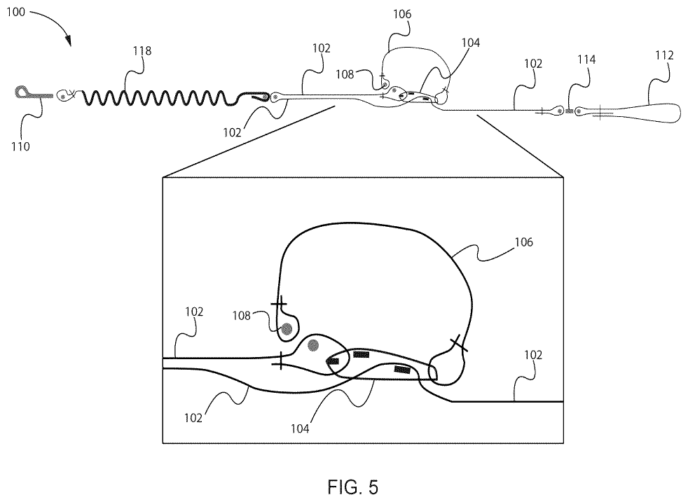

Referring to FIG. 5, a side view of the leash 100 is shown in an extended configuration, along with an enlarged detail view showing the arrangement of components. The leash strap 102 extends along the length of the leash 100, forming the primary tether material. As described previously, an elastic band 118 is positioned distal to the second end of the leash strap 102. The elastic band 118 connects to the leash clip 110, which is configured to attach to a collar or harness of an animal. The elastic band 118 is configured to provide shock absorption during use, reducing jarring forces transmitted through the leash 100 when the animal pulls or lunges.

With continued reference to FIG. 5, the leash strap 102 extends from the elastic band 118 through the adjustment bracket 104, which is positioned along the leash strap 102. The loop strap 106 is connected to the adjustment bracket 104 via the loop ring 108. The leash strap 102 continues toward the handle strap 112, which includes the swivel connector 114 that allows rotational movement.

The enlarged detail view in FIG. 5 shows the interaction between the leash strap 102, the adjustment bracket 104, the loop strap 106, and the loop ring 108. The leash strap 102 is woven through the adjustment bracket 104 to create the pulley-like adjustment system. The loop strap 106 forms a curved configuration around the loop ring 108 to connect to the leash strap 102. The leash strap 102 passes through multiple points of the adjustment bracket 104 to enable dynamic length adjustment of the leash 100.

The elastic band 118 may be replaced with other shock-absorbing materials or mechanisms. In some cases, the elastic band 118 may comprise bungee cord material that provides elasticity and energy absorption. In some cases, coiled spring elements may be employed in place of the elastic band 118 to absorb sudden forces. In some cases, rubber segments may be incorporated to reduce jarring from sudden pulls by the animal. The leash strap 102 may comprise a rugged bungee cord material for added shock absorption to reduce jarring from sudden pulls by the animal.

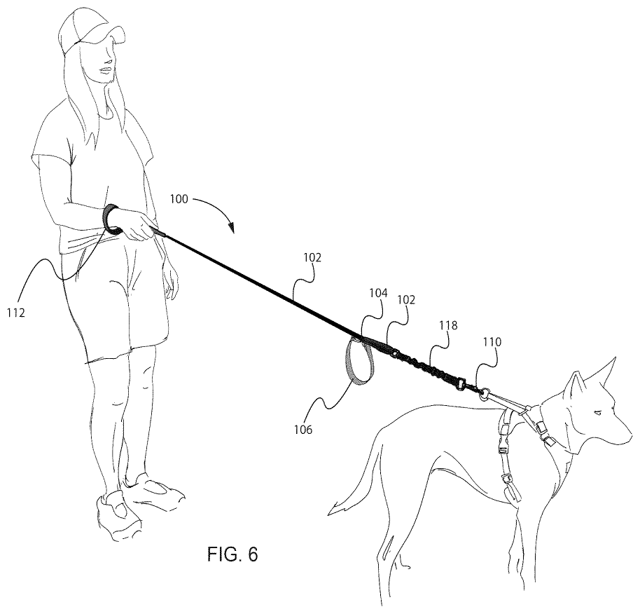

Referring to FIG. 6, a perspective view of the leash 100 is shown in use with a person walking a dog. The leash 100 extends from the person to the dog, demonstrating the practical application of the leash 100 during a walking scenario. The handle strap 112 is positioned around the person's hand, providing a secure grip for controlling the dog. The handle strap 112 forms a loop that wraps around the hand and wrist of the user, allowing the user to maintain control of the leash 100 even when the dog pulls or changes direction.

With continued reference to FIG. 6, the leash strap 102 extends from the handle strap 112 toward the dog, forming the primary tether between the person and the animal. The adjustment bracket 104 is positioned along the leash strap 102, enabling dynamic adjustment of the leash length during use. As described previously, the loop strap 106 forms a secondary handle that enables dynamic length adjustment of the leash 100 by applying a force to the loop strap 106 in a first direction. The loop strap 106 is positioned along the leash strap 102 and provides an intermediate grip point between the handle strap 112 and the leash clip 110. The intermediate grip point provided by the loop strap 106 allows the user to grasp the loop strap 106 with a second hand while maintaining grip on the handle strap 112 with a first hand.

As further shown in FIG. 6, the elastic band 118 is incorporated into the leash 100 adjacent the distal end of the leash strap 102, providing shock absorption and flexibility when the dog moves or pulls. The leash clip 110 is attached at the distal end of the leash 100, connecting to the dog's harness to secure the animal. The configuration shown in FIG. 6 demonstrates how the leash 100 allows the user to maintain control over the dog while providing the ability to adjust the effective length of the tether as desired during walking.

The leash 100 may include an extra traffic handle configuration for enhanced grip and control in high-traffic or safety-critical scenarios. In some cases, the extra traffic handle configuration may be positioned along the leash strap 102 between the adjustment bracket 104 and the leash clip 110, for example proximate to a distal portion of the leash 100 to allow the handler to hold the dog close. In some cases, the extra traffic handle configuration may comprise a sewn loop formed by folding a section of the leash strap 102 back on itself and securing it with stitching such as bar tacks or box-and-cross patterns. In other cases, the extra traffic handle configuration may comprise a separate short strap coupled to the leash strap 102 using hardware such as a D-ring, an O-ring, a tri-glide, rivets, or other fasteners. The handle region may include padding or high-friction materials (e.g., neoprene or foam wraps, rubberized or silicone sleeves) and/or reinforced webbing layers to improve comfort and durability. In some cases, reflective accents or textured coverings may be incorporated to improve visibility and grip. The extra traffic handle configuration may function as a third grip point that works in conjunction with the primary handle (handle strap 112) and the secondary handle (loop strap 106), enabling hand-over-hand transitions, rapid shortening, or momentary close control without altering operation of the pulley-like adjustment system. In some cases, the extra traffic handle configuration may be fixed, removable, or adjustable along the leash strap 102 depending on the attachment method.

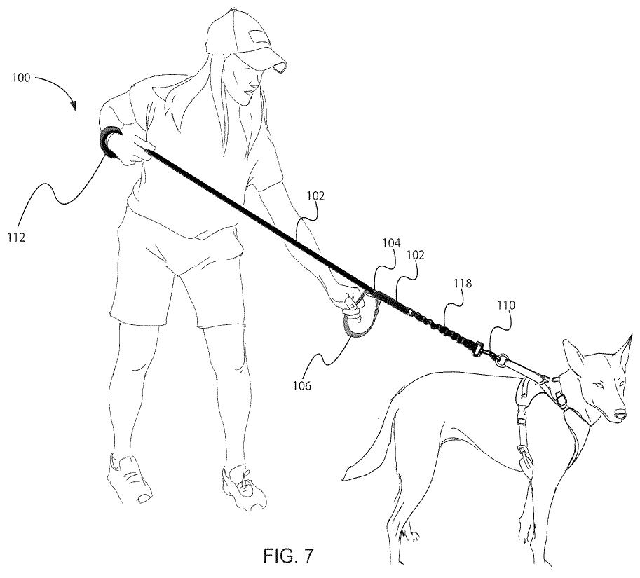

Referring to FIG. 7, a perspective view of the leash 100 is shown in use with a person walking a dog, where the person is leaning forward to grasp the loop strap 106 in anticipation of shortening the leash length. The leash 100 extends from the person to the dog, with the handle strap 112 held in the person's raised hand. The person is reaching toward the loop strap 106 with a second hand while maintaining grip on the handle strap 112 with a first hand.

With continued reference to FIG. 7, a method of adjusting a length of the leash 100 is illustrated. The method comprises gripping the handle strap 112 positioned at a first end of the leash strap 102 with a first hand. As described previously, the handle strap 112 forms a primary handle loop for gripping by the user, and the handle strap 112 is positioned at the first end of the leash strap 102. The user maintains control of the leash 100 through the handle strap 112 while preparing to adjust the leash length.

The method further comprises grasping the loop strap 106 with a second hand. As shown in FIG. 7, the person is gripping the loop strap 106 in anticipation of shortening the leash length by pulling on the loop strap 106. The loop strap 106 is connected at one end to an adjustment bracket 104 and at another end to the leash strap 102 via a loop ring 108. As described previously, the adjustment bracket may comprise a ladder lock 104 or other adjustment bracket types such as a tri-glide buckle, a cam buckle, or other sliding adjustment mechanisms. The loop ring 108 provides the connection between the loop strap 106 and the leash strap 102.

As further shown in FIG. 7, the adjustment bracket 104 is positioned along the leash strap 102. The leash strap 102 is threaded through the adjustment bracket 104 to form a pulley-like system. The pulley-like system enables dynamic length adjustment of the leash 100 when the user applies a force to the loop strap 106. The elastic band 118 is positioned between the adjustment bracket 104 and the leash clip 110, and the leash clip 110 is attached to a harness worn by the dog. The configuration shown in FIG. 7 demonstrates the leash 100 in an operational configuration where the person may dynamically adjust the length of the leash 100 by pulling on the loop strap 106 to manipulate the adjustment bracket 104 to shorten the leash length while maintaining control of the dog through the handle strap 112.

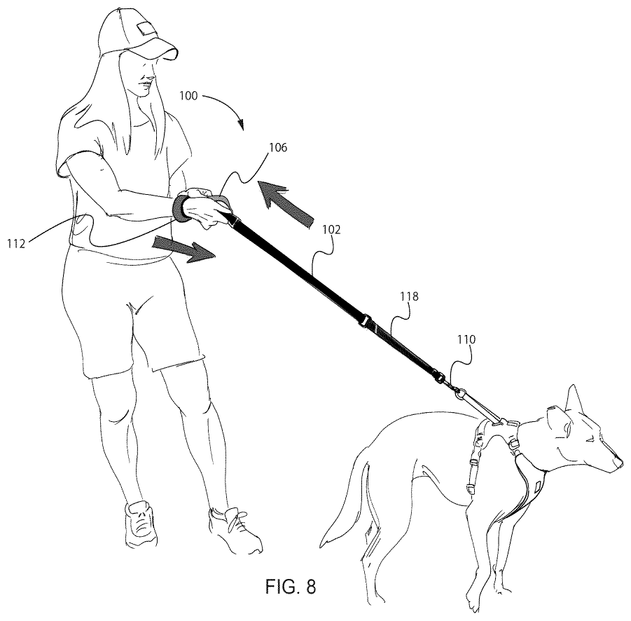

Referring to FIG. 8, a perspective view of the leash 100 is shown in use with a user walking a dog, where the leash 100 is in a shortened length configuration. The loop strap 106 has been pulled all the way to the proximal end of the leash 100, positioning the loop strap 106 near the user's hand adjacent the handle strap 112. The user holds the handle strap 112, which forms a loop around the user's hand and wrist, while the loop strap 106 is positioned near the user's hand to provide a grip point for controlling the leash 100 in the shortened length configuration.

With continued reference to FIG. 8, as described previously, applying a force to the loop strap 106 in a first direction causes the adjustment bracket 104 to slide along the leash strap 102 to shorten an effective length of the leash 100. In the embodiment shown in FIG. 8, the first direction is toward a user such that pulling the loop strap 106 toward the user shortens the effective length of the leash 100. Red arrows in FIG. 8 indicate the direction of force or movement along the leash 100. The arrows suggest the pulling action by the user during use to shorten the leash length and the pushing action by the user during use to lengthen the leash length. Pushing the loop strap 106 away from the user extends the effective length of the leash 100, returning the leash 100 toward the full length configuration.

The full length and shortened length configuration dimensions described herein are merely examples, and other lengths are possible without departing from the scope of the invention. The selection of leash length dimensions may depend on various factors including the size and breed of the animal, the intended use environment, handler preferences, and local regulations regarding leash lengths in public spaces. For larger or more active animals, a full length of 8 feet or 10 feet may be desirable to provide additional freedom of movement during outdoor activities, with the shortened length configuration reducing to approximately 4 feet or 5 feet respectively. For smaller animals or urban environments with limited space, a full length of 4 feet may be appropriate, with the shortened length configuration reducing to approximately 2 feet. In some cases, the leash 100 may be configured with a full length of 7 feet and a shortened length of approximately 3.5 feet. The ratio between the full length configuration and the shortened length configuration may vary based on the threading pattern of the leash strap 102 through the adjustment bracket 104, with different threading configurations enabling different reduction ratios such as one-third or two-thirds of the full length rather than approximately half.

As further shown in FIG. 8, the leash 100 is configured to be adjustable between a full length configuration and a shortened length configuration. The shortened length configuration is approximately half of the full length configuration. In some cases, the leash 100 may have a full length of 5 feet in the extended position, allowing the dog natural freedom of movement during walks or activities. The leash 100 may have a shortened position of approximately 3 feet for situations requiring closer control, such as in crowded areas, near traffic, or when quick restraint is desired. In some cases, the leash 100 may have a full length of 6 feet in the extended position, with the shortened length configuration reducing the effective length to approximately 3 feet. The pulley-like system created by the leash strap 102 threaded through the adjustment bracket enables the leash 100 to dynamically halve the overall length, thereby shortening an effective length of the leash 100 when the user applies a force to the loop strap 106 in the first direction to cause the adjustment bracket 104 to slide along the leash strap 102. The configuration shown in FIG. 8 demonstrates the leash 100 in the shortened length configuration, allowing the user to maintain close control over the dog through the handle strap 112 and the loop strap 106 while the dog remains within the reduced effective length of the leash strap 102.

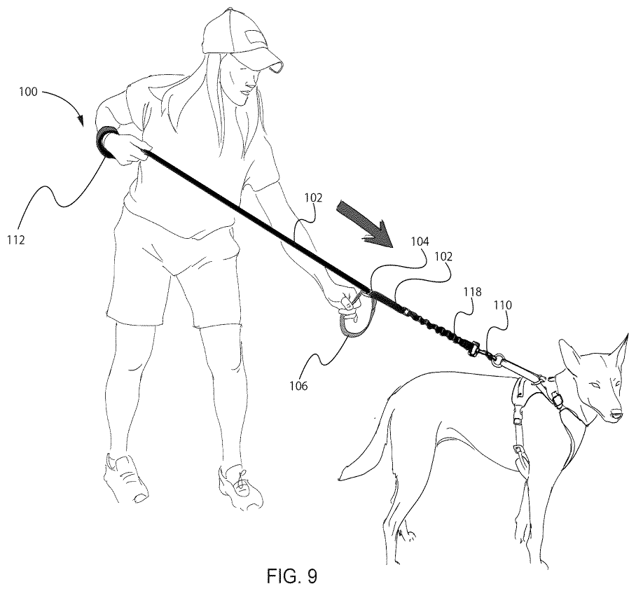

Referring to FIG. 9, a perspective view of the leash 100 is shown in use with a person walking a dog, where the leash 100 is in an extended length configuration with the loop strap 106 pushed to the middle section of the leash 100. The leash 100 extends from the handle strap 112 held by the person to the leash clip 110 attached to the dog's harness. The handle strap 112 is positioned at the proximal end of the leash 100, allowing the person to maintain grip and control. The leash strap 102 passes through the adjustment bracket 104, which is positioned along the length of the leash strap 102.

With continued reference to FIG. 9, as described previously, applying a force to the loop strap 106 in a first direction causes the adjustment bracket 104 to slide along the leash strap 102 to shorten an effective length of the leash 100. Applying a force to the loop strap 106 in a second direction opposite the first direction causes the effective length of the leash 100 to extend. A red arrow in FIG. 9 indicates the direction of movement or adjustment of the adjustment bracket 104 along the leash strap 102, which is achieved by pushing the loop strap 106 in the second direction. The loop strap 106 is visible near the adjustment bracket 104, providing a grip point for the user to apply the force in the second direction to extend the leash length.

In the embodiment shown in FIG. 9, the first direction is toward a user and the second direction is away from the user such that pulling the loop strap 106 toward the user shortens the effective length of the leash 100 and pushing the loop strap 106 away from the user extends the effective length of the leash 100. As described previously with reference to FIG. 2, an alternate configuration may be employed where the first direction is away from a user and the second direction is toward the user such that pushing the loop strap 106 away from the user shortens the effective length of the leash 100 and pulling the loop strap 106 toward the user extends the effective length of the leash 100.

The method of adjusting a length of the leash 100 may further comprise applying a force to the loop strap 106 in a second direction opposite the first direction to extend the effective length of the leash 100. As described previously, the method comprises gripping the handle strap 112 positioned at a first end of the leash strap 102 with a first hand and grasping the loop strap 106 with a second hand. When the user desires to extend the effective length of the leash 100, the user applies a force to the loop strap 106 in the second direction, causing the adjustment bracket to slide along the leash strap 102 in a manner that increases the effective length of the leash 100 between the handle strap 112 and the leash clip 110.

The leash 100 is configured to be adjustable to any size between the full length and the shortened length, not just discrete positions. The pulley-like system created by the leash strap 102 threaded through the adjustment bracket enables continuous length adjustment rather than discrete positions. The user may position the loop strap 106 at any point along the leash strap 102 between the fully extended position and the fully shortened position, allowing the user to select an intermediate effective length that suits the particular situation. This continuous adjustment capability provides the user with flexibility to adapt the effective length of the leash 100 to varying conditions encountered during use, such as transitioning from an open area to a moderately crowded space where a length between the full length and the shortened length may be appropriate.

The components of the leash 100 interact to perform the function of dynamic length adjustment through a coordinated mechanical arrangement. The leash strap 102 threaded through the adjustment bracket 104 creates a pulley-like system that enables the effective length of the leash 100 to be modified during use. The leash strap 102 passes through multiple points of the adjustment bracket 104, and this threading configuration allows the adjustment bracket 104 to slide along the leash strap 102 when a force is applied. The pulley-like system created by the leash strap 102 and the adjustment bracket 104 enables the leash 100 to dynamically halve the overall length or achieve intermediate lengths between the full length configuration and the shortened length configuration.

The loop strap 106 connected to the leash strap 102 via the loop ring 108 enables a user to manipulate the adjustment bracket 104 position along the leash strap 102. The loop ring 108 provides a connection point between the loop strap 106 and the leash strap 102 at one end of the loop strap 106. At its other end, the loop strap 106 is connected to the adjustment bracket 104. When the user applies a force to the loop strap 106, the force is transmitted through the loop ring 108 to cause the adjustment bracket 104 to slide along the leash strap 102. The loop strap 106 forms a secondary handle that the user may grasp with a second hand while maintaining grip on the handle strap 112 with a first hand. This two-handed operation allows the user to adjust the effective length of the leash 100 while maintaining control over the animal.

The handle strap 112 provides primary control of the leash 100 during use. The handle strap 112 forms a primary handle loop that wraps around the hand and wrist of the user, allowing the user to maintain a secure grip on the leash 100 even when the animal pulls or changes direction. The loop strap 106 forms a secondary handle for adjustment, and the user may grasp the loop strap 106 to apply a force in a first direction to shorten the effective length of the leash 100 or in a second direction to extend the effective length of the leash 100. The combination of the handle strap 112 as the primary handle and the loop strap 106 as the secondary handle provides the user with multiple grip points for controlling the leash 100 and adjusting the leash length.

The swivel connector 114 prevents tangling during use by allowing rotational movement between the handle strap 112 and the leash strap 102. When the animal moves around the user or changes direction, the swivel connector 114 rotates to accommodate the movement without causing the leash strap 102 to twist or tangle. This rotational capability maintains the functionality of the pulley-like system by preventing the leash strap 102 from binding within the adjustment bracket 104 due to accumulated twisting.

As described previously, the elastic band 118 is positioned distal to a second end of the leash strap 102. The elastic band 118 provides shock absorption when an animal attached to the leash 100 pulls against the leash 100. When the animal lunges or changes direction suddenly, the elastic band 118 stretches to absorb the sudden force, reducing jarring transmitted through the leash 100 to the user's hand and arm. The shock absorption provided by the elastic band 118 may reduce strain on both the user and the animal during use.

The interaction of these components avoids the tangling, jamming, or line retraction issues common in traditional retractable leashes. Traditional retractable leashes employ mechanical retraction systems with thin cords or tapes that may jam within the retraction mechanism, tangle around the housing, or fail to accurately control the length during retraction. The leash 100 described herein employs the pulley-like system created by the leash strap 102 threaded through the adjustment bracket 104, which does not rely on mechanical retraction mechanisms that may jam or fail. The leash strap 102 may comprise webbing material that provides a wider, more robust tether compared to the thin cords used in traditional retractable leashes.

The leash 100 provides firm, non-elastic control when shortened. When the user shortens the effective length of the leash 100 by applying a force to the loop strap 106, the leash strap 102 between the handle strap 112 and the leash clip 110 remains non-elastic, providing direct physical control over the animal. The elastic band 118 positioned distal to the second end of the leash strap 102 provides shock absorption without compromising the firm control provided by the leash strap 102 in the shortened length configuration. This arrangement allows the user to maintain leverage and control over the animal in situations requiring closer control, such as in crowded areas, near traffic, or when quick restraint is desired, while the elastic band 118 absorbs sudden forces that may occur when the animal pulls against the leash 100.

A number of implementations have been described. Nevertheless, it will be understood that various modifications may be made without departing from the spirit and scope of the disclosure. Accordingly, other implementations are within the scope of the following claims.

1. A leash comprising:
a leash strap extending between a first end and a second end;
an adjustment bracket positioned along the leash strap, the leash strap being threaded through the adjustment bracket to form a pulley-like system;
a loop strap connected at one end to the adjustment bracket and at another end to the leash strap; and
the loop strap forming a secondary handle that enables dynamic length adjustment of the leash by applying a force to the loop strap in a first direction, wherein applying the force to the loop strap in the first direction causes the adjustment bracket to slide along the leash strap to shorten an effective length of the leash.

2. The leash of claim 1, further comprising a handle strap positioned at the first end of the leash strap, the handle strap forming a primary handle loop for gripping by a user.

3. The leash of claim 2, further comprising a swivel connector connecting the handle strap to the leash strap, the swivel connector configured to allow rotational movement to prevent tangling during use.

4. The leash of claim 3, further comprising a handle ring positioned at the first end of the leash strap proximate the swivel connector.

5. The leash of claim 1, further comprising a leash clip attached at the second end of the leash strap, the leash clip configured for attachment to a collar or harness of an animal.

6. The leash of claim 1, further comprising an elastic band positioned distal to the second end of the leash strap, the elastic band configured to provide shock absorption during use.

7. The leash of claim 1, wherein the leash strap comprises a webbing material.

8. The leash of claim 1, wherein the loop ring comprises a D-ring or an O-ring.

9. The leash of claim 1, wherein the leash is configured to be adjustable between a full length configuration and a shortened length configuration, the shortened length configuration being approximately half of the full length configuration.

10. The leash of claim 1, wherein applying a force to the loop strap in a second direction opposite the first direction causes the effective length of the leash to extend.

11. The leash of claim 10, wherein the first direction is toward a user and the second direction is away from the user such that pulling the loop strap toward the user shortens the effective length of the leash and pushing the loop strap away from the user extends the effective length of the leash.

12. The leash of claim 10, wherein the first direction is away from a user and the second direction is toward the user such that pushing the loop strap away from the user shortens the effective length of the leash and pulling the loop strap toward the user extends the effective length of the leash.

13. A method of adjusting a length of a leash, the method comprising:
gripping a handle strap positioned at a first end of a leash strap with a first hand;
grasping a loop strap with a second hand, the loop strap being connected at one end to an adjustment bracket, and at another end to the leash strap, the adjustment bracket being positioned along the leash strap, wherein the leash strap is threaded through the adjustment bracket to form a pulley-like system; and
applying a force to the loop strap in a first direction to cause the adjustment bracket to slide along the leash strap, thereby shortening an effective length of the leash.

14. The method of claim 13, further comprising applying a force to the loop strap in a second direction opposite the first direction to extend the effective length of the leash.

15. The method of claim 14, wherein the first direction is toward a user and the second direction is away from the user such that pulling the loop strap toward the user shortens the effective length of the leash and pushing the loop strap away from the user extends the effective length of the leash.

16. The method of claim 14, wherein the first direction is away from a user and the second direction is toward the user such that pushing the loop strap away from the user shortens the effective length of the leash and pulling the loop strap toward the user extends the effective length of the leash.

17. The method of claim 13, wherein the leash further comprises an elastic band positioned distal to a second end of the leash strap, the elastic band providing shock absorption when an animal attached to the leash pulls against the leash.

18. A leash system comprising:
a leash strap extending between a first end and a second end;
a handle strap positioned at the first end of the leash strap, the handle strap forming a primary handle loop;
a swivel connector connecting the handle strap to the leash strap;
an adjustment bracket positioned along the leash strap, the leash strap being threaded through the adjustment bracket to form a pulley-like system that enables dynamic length adjustment;
a loop strap connected at one end to the adjustment bracket and at another end to the leash strap, the loop strap forming a secondary handle; and
a leash clip attached at the second end of the leash strap, the leash clip configured for attachment to a collar or harness worn by an animal.

19. The leash system of claim 18, wherein applying a force to the loop strap in a first direction causes the adjustment bracket to slide along the leash strap to shorten an effective length of the leash, and applying a force to the loop strap in a second direction opposite the first direction causes the effective length of the leash to extend.

20. The leash system of claim 19, wherein the first direction is toward a user and the second direction is away from the user such that pulling the loop strap toward the user shortens the effective length of the leash and pushing the loop strap away from the user extends the effective length of the leash.
